(19) United States
(12) Patent Application Publication
(10) Pub. No.: US 2008/0036587 A1
(43) Pub. Date: Feb. 14, 2008

(54) Race tracking system and method

(76) Inventors: Seth Meinzen, Overland Park, KS (US); Steve Meinzen, Overland Park, KS (US)

Correspondence Address: Mark Manley, University of Central Missouri, Dockery Building Room 102, Warrensburg, MO, 64093, US

(21) Appl. No.: 11/891,471

(22) Filed: Aug. 10, 2007

Related U.S. Application Data
(60) Provisional application No. 60/836,622, filed on Aug. 10, 2006.

(51) Int. Cl. G08B 1/08; H04Q 7/00

(52) U.S. Cl. 340/539.13

(57) ABSTRACT

A method for continually and precisely tracking objects over a set distance that includes a starting point and a finishing point. A reference point, RTK, is established with in the set distance. GPS nodes are connected to each object and periodically transmit a location signal and identification code of the say object within the set distance. The node receives the location signal and verifies the accuracy with the reference device. The node sends the location signal and identification code to the remote collection unit that calculates actual speed, course, and heading of the object and organizes the information into data packets. The data is then used to create an animated image of the objects and there course. A server transmits the data packets and animation through the Internet to adjacent servers that will be accessed using specific mobile and Internet applications. Information is added at the servers to the live animated transmission.

### RELATED APPLICATIONS

This application claims the benefit of PPA Ser. No. 60/836,622 filed Aug. 10, 2006 which is incorporated by reference.

### BACKGROUND OF THE INVENTION

There is a need to track action as it occurs in a sporting environment. At many events spectators are left to their own eyes and maybe to binoculars to try to track sports action as it occurs. Some sporting venues use cameras to provide large televisions to track action via video and present the action to spectators on a large screen visible from a stadium for example. For some events like cross country and bike touring the fan can only see a very small portion of the action at any one time.

GPS, or global positioning system, operates by satellites in space triangulating the position of a node, or point of interest. The accuracy of the GPS system alone is typically around five meters. Prior U.S. Pat. Nos. 6,002,982 and 6,657,584 are U.S. patents that references using GPS data to track sports performance. These prior patent use GPS to provide a rough tracking but provide no opportunity for fan interaction and use of the data generated.

The principal prior art technologies being utilized to track races are RFID tags and video cameras. Both have very rigid shortcomings when tracking races over large geographical areas. Both technologies do utilize transmitters.

RFID, radio frequency identification, technology operates by attaching a tag to each object entered in a race and when the tagged object crosses over a transmitter in a set area, the transmitter marks a time-stamp or the time the tag crossed the transmitter. When the tag crosses over additional transmitters and additional timestamps are recorded an application calculates the average speed of the object between the current and past time stamps. This average speed can then be estimated for the future. RFID tags are unable to show the exact position of an object over time, except when crossing over a transmitter and recording a time stamp, and is unable to track the course and actual speed of the object. There are obvious limitations to using RFID tags to most races such as boat racing where the tag would need to be in the water for example.

### BRIEF SUMMARY OF THE INVENTION

A method for tracking objects motion in real-time and over time, comprising the steps of: specifying specific longitude and latitude coordinates to generating a map or specified area in which to track objects; coupling at least one GPS node to at least one object to be tracked in the specified area; placing a Real time kinematics (RTK) reference point within the specified area; periodically transmitting, at least once per second, between the GPS node and the GPS satellites; periodically transmitting, at least once per second, between the GPS node and the RTK reference point. Receiving the location of the GPS node coupled with the object between one meter and one centimeter; transmitting the location and heading of the object from the GPS node to the central collection point; receiving and organizing location and heading of each object in real-time, periodically transmitting, at least once per second, location and heading to an adjacent server; receiving the location and heading of each object by the adjacent server; generating a digital representation of the location and heading of each object by specialized software within the adjacent server; generating speed and course of each object in real-time and overtime; periodically transmitting, at least once per second, digital representation of the objects in a race to the central collection point, to a computer network such as the Internet and cellular devices; and receiving the digital representation of the objects in a race by central collection point, the Internet and cellular devices in real-time.

### BRIEF DESCRIPTION OF THE DRAWING

FIG. 1 is a race track using the present invention,

FIG. 2 is a flowchart of the process,

FIG. 3 shows a screen shot of a device using the invention,

FIG. 4 shows a relational diagram of some of the components of the invention,

FIG. 5 shows the race track overlaid with a coordinate grid,

FIG. 6 shows a flowchart of the track setup,

FIG. 7 shows the steps of creating a live animated representation of an actual live race,

FIG. 8 shows the steps of how the system handles events that may occur during a race,

FIG. 9 shows the steps of how a gamer can race in a digital representation of a historical race.

### DETAILED DESCRIPTION OF THE INVENTION

The race tracking system of the present invention will monitor and record the movement of objects within a set distance over time. It could be used for closed tracks such as oval or circular racetracks used in car racing or it can be used for more open ended tracks such as cross country racing or regatta racing that might occur on a body of water. The present invention uses Global positioning (GPS) devices (nodes) and RTK technologies to accurately track the location of each racing object. Specialized software will generate a digital representation of a race object to be shown to third party viewers. Third party viewers will be able to view the digital representation on network, web and cellular-enabled devices.

Applications for this invention include racing sports, sports that cover large distances, activities or events needing to track objects over long or large distances. Such sports include but are not limited to, biking, sailing, rowing, running, horse racing, dog racing, camel racing, skiing, jet/speed boat racing, and flying. This invention provides advantages for the communication, transmission and broadcast of racing and sports events. This invention will enhance video broadcasts by providing more information about the movements of each object in the race.

The method for tracking each object's movement in the present invention requires two phases; the tracking phase records the position of each GPS node over time, and the code phase gathers, sorts, and presents the position and the speed of the objects to an end user.

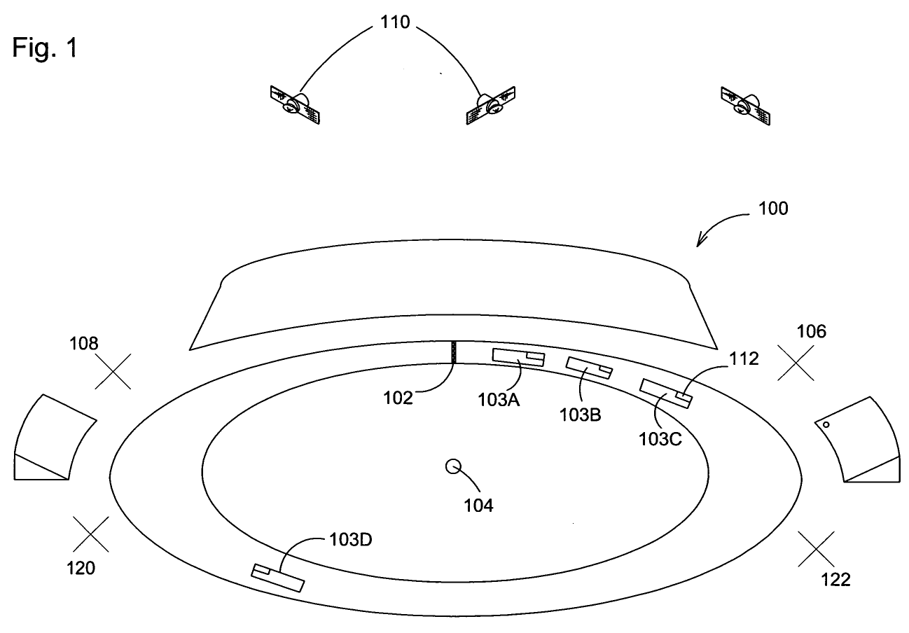

FIG. 1 shows a race track 100 where the present device might be used. The track 100 includes some physical features such as a start/finish line 102 and boundary points 106, 108, 120 and 122 that tend to set the boundaries of the race track 100. On the race track 100 are race objects 103A, 103B, 103C; which could be race cars, horses or sprinters for example. Each race object 103 includes a GPS node 112. At the center of the track 100 can be an RTK reference point 104 that allows for more precise location of each object 103 then would otherwise be possible with GPS alone.

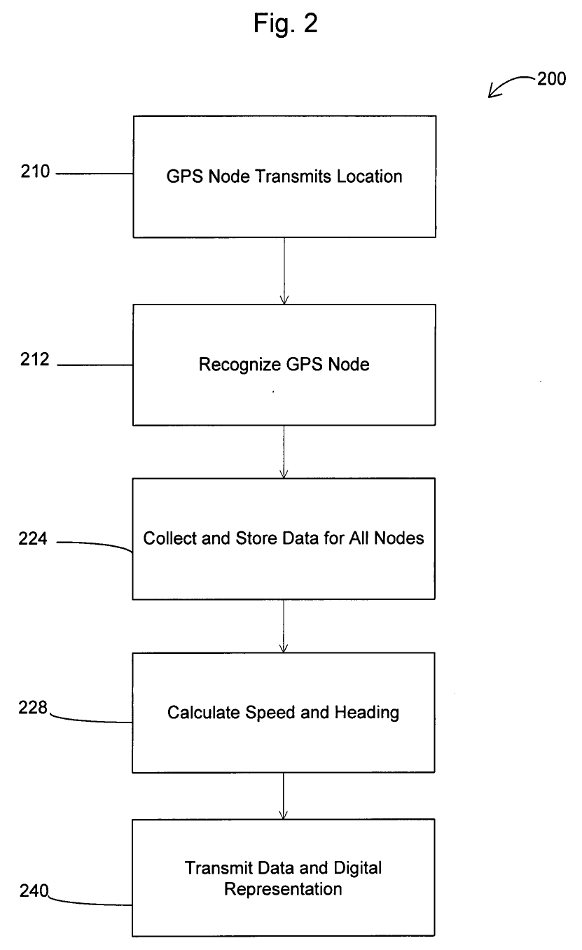

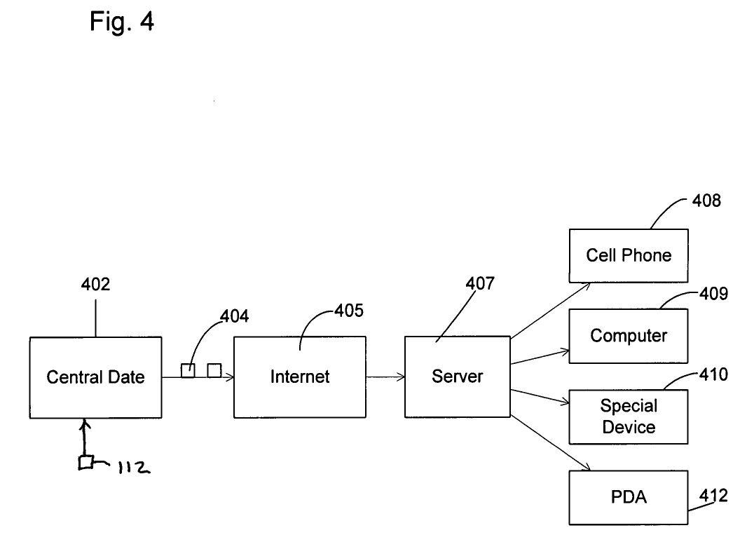

The tracking phase 200 (FIG. 2) requires at least one GPS node 112 to be attached to each object 103, at least one RTK reference point 104 at each race, at least one central collection unit 402 (FIG. 4), and at least one point of connection to the Internet 405. The code phase 300 requires a specialized software application through which an object 103 and a GPS node 112 identification numbers can be inputted and a server to run the specialized software application represented by the flowcharts in FIGS. 2, 6, 7, 8 and 9.

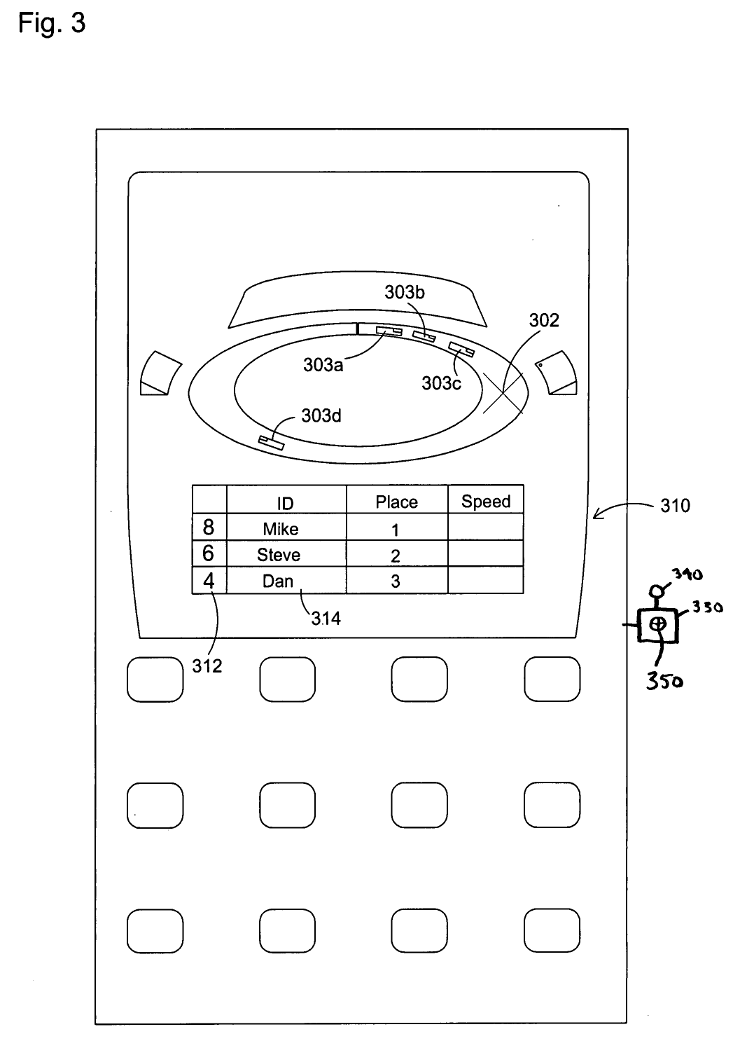

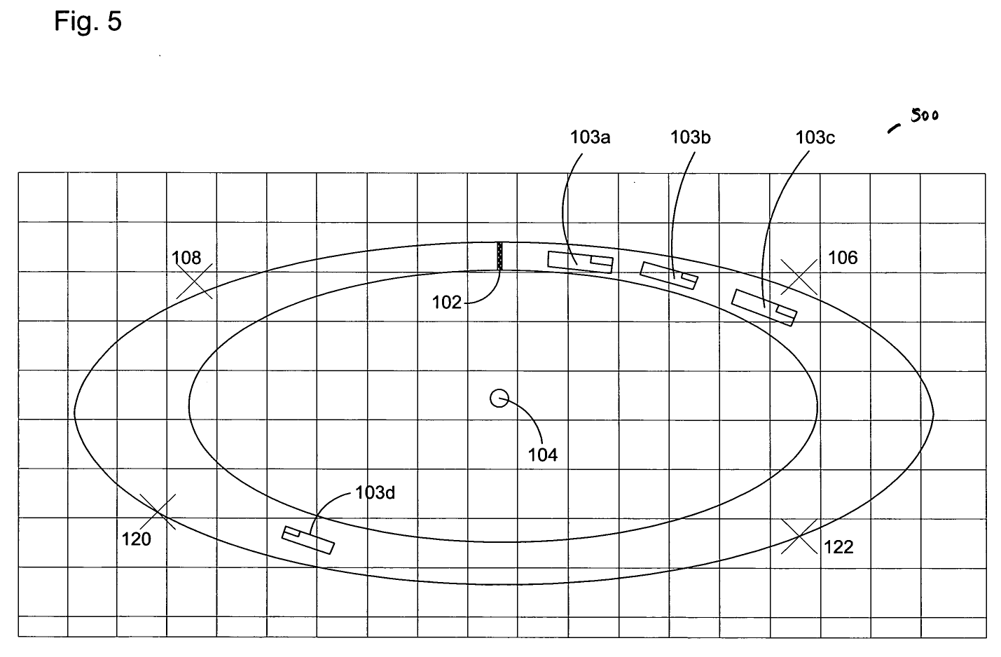

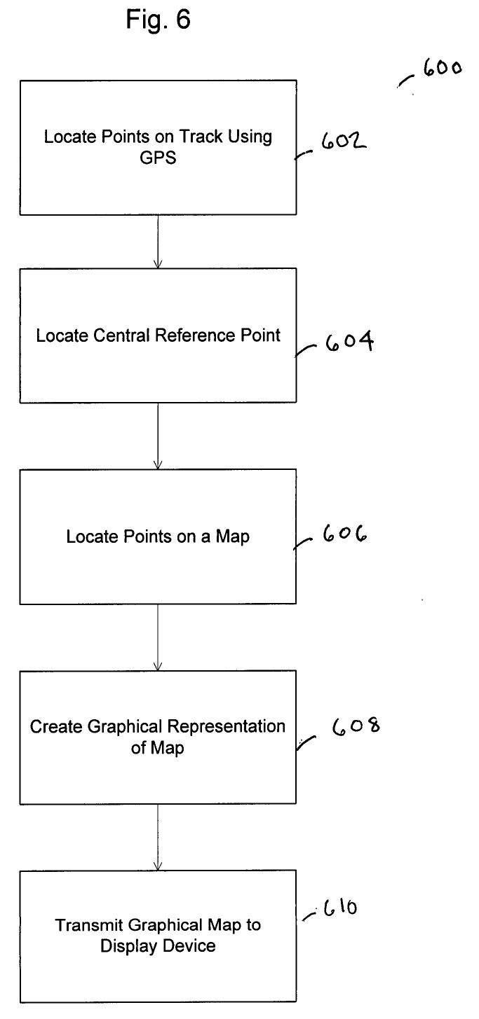

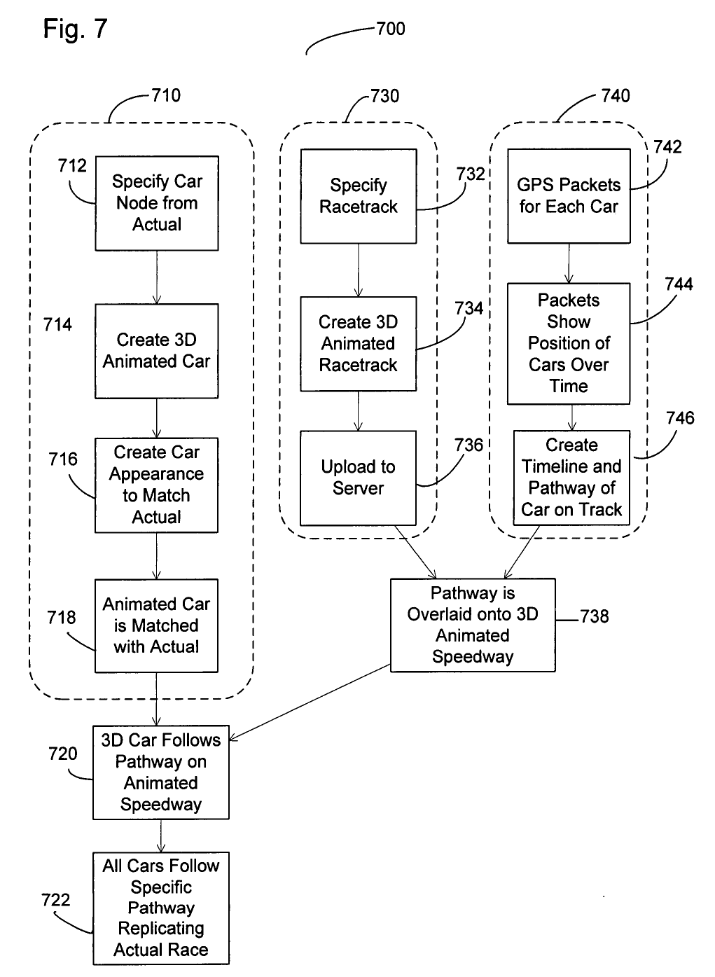

The tracking phase 200 is directed toward the physical collection of positioning coordinates (see FIG. 5) and the code phase 600 in FIG. 6, is directed at directing the flow and organization of information throughout the process, but both phases overlap. Both phases are utilized prior to the race commencing, as the racecourse 100 and area must be plotted out for the digital representation (see FIG. 3) and each car is specified (FIG. 7) for 3 dimensional representation, referred to herein as ‘3D’. A GPS node 112 and the specialized application is used to map out the locations of points of interest; specifically landmarks such as start and finishing points 102, the course of the race 100, and the boundary corners of the intended race map area 106, 108, 120 and 122. This is done by briefly placing a GPS node 112 at the point of interest such as the start/finish line 102, located within the racetrack 100, for a few seconds, enabling the exact position coordinates of the landmark to be found. GPS is also used to create a 3D representation of each car 103 to be stored in the server 407. After the point of interest is recorded the process is repeated until all points of interest 102, 104, 106, 108, 120 and 122 for example are located and all cars are specified. FIG. 5 shows the specialized application is then utilized to bring in a satellite map 500. The map 500 is made to fit by matching the position coordinates of the intended race map points of interest 102,104,106,108,120 and 122 with the actual latitude and longitude coordinates of a satellite map 500. The satellite map 500 is then changed to a digital representation 302 of the satellite map 500 for better viewing. The mapping process can use as many points as required to accurately represent the race course 100 and can include points off the track 100 such as corner points that might define a rectangle to enclose an entire track 100.

The tracking phase 600 is accountable for measuring and storing the object's 103 position both presently and over time. To measure the object's 103 position a GPS node 112 is attached to each object 103. The GPS node 112 is able to locate the exact latitude and longitude coordinates of the object 103 from the triangulation of GPS satellites 110 located in space and from the RTK reference point 104. To work the system needs to have access to at least 4 satellites 110 and typically 5. The accuracy of the position coordinates for the object 103 will be less than a meter with the GPS satellites 110 alone and less than a centimeter with the GPS satellites 110 and RTK reference point 104 together. The GPS node 112 can transmit the position coordinates between one time-per-second to one thousand times-per-second. The position coordinates are transmitted to a central collection unit 402.

As shown in FIG. 4, the central collection unit 402 is capable of gathering position coordinates from over a thousand different GPS nodes 112 and pertaining to thousands of different objects 103 of which only 4 are shown in FIG. 1. The central collection unit 402 organizes the position coordinates from all the different objects 103 and adds the 3D information about each car 103 into data packets 404. The data packets 404 are sent through the Internet 405 to adjacent servers 407. The central collection unit 402 is able to connect to the Internet 405 using a satellite communication link and dish or by using radios that are meshed together in a network to connect the central collection unit 402 to an adjacently located Internet hub 405 for example.

In the code phase 200, as the GPS node 112 is attached to an object 103 the specialized application is responsible for labeling the specific GPS node 112 that correlates to a specific object 103. As the GPS node 112 transmits the object's 103 position coordinates to the central collection unit 402 the specialized application allows the central collection unit 402 to sort and differentiate each object 103 and its position coordinates and orientation from other objects 103 and position coordinates. The specialized application is responsible for recognizing the method available to send data packets 404 to the Internet 405 and optimizing it for the central collection unit 402.

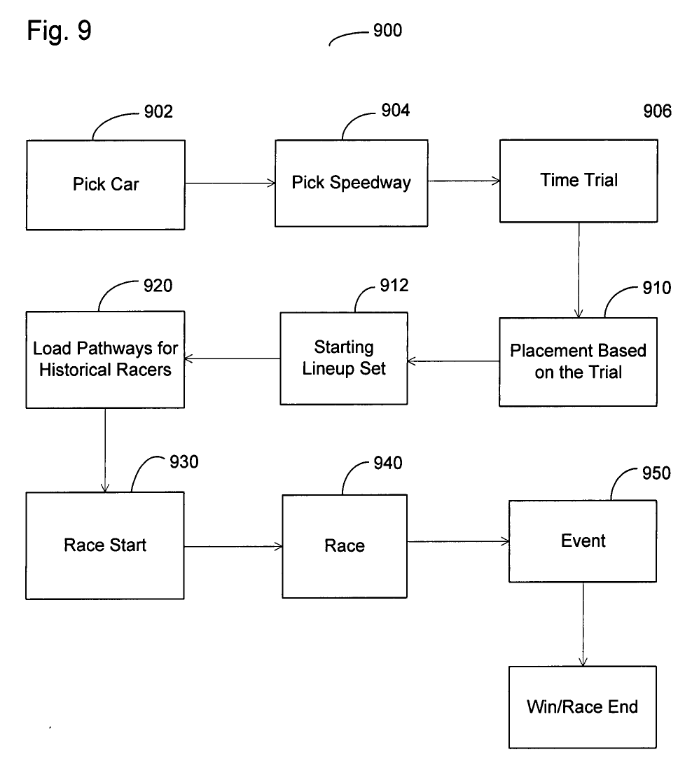

As the adjacent servers receive the data packets the specialized application sorts each specific object's information and generates a digital representation 302 from the data packet. The specialized application is responsible for continually updating the digital object representation 303 a, b, c, d of each object 103 a, b, c, d and displaying the speed, direction of movement, and object's course over time. Each digital object 303 can include an identifying mark such as a number, name or color as well as 3D data that will allow a spectator to distinguish digital objects 303 and to relate the digital object 303 to the actual object 103. FIG. 3 shows a data display 310 that includes object numbers 312, names 314 the position or place 316 the object currently holds in the race and speed 320 of the object. The data display 310 is updated periodically as the race continues. The data display 310 can include a controller 330 that allows a user to have a joy stick 340 and steering wheel 350 for example for use in the playback mode of the device shown in FIG. 9.

The specialized application directs the digital representation 302 to a network such as the Internet 405 that can display the digital representation. The digital representation 302 can be viewed by any web-enabled device such as, computer 409, special device 410 or PDA 412 for example the digital representation 302 of a race can also be stored and replayed later and the stored race can be modified to allow a gamer to race in historical races as shown in the process in FIG. 9. The specialized application is responsible for sending the digital representation 302 back to the central collection unit 402 so that it can be viewed and reviewed at the location of the race or later. The specialized application is able to direct the digital representation 302 to be sent through the adjacent server to cellular communications. Allowing any cellular phone 408 or cellular-enabled device to ascertain the digit representation and view it.

The present invention is tracking races through the use of GPS and RTK technologies, as shown in FIG. 2 for illustration purposes. The present invention resides in the unique process of tracking objects 103 that are racing, and the present invention is combination of hardware and unique software.

The present invention is the process of combining three established systems: GPS nodes, a network of GPS satellites, and an RTK reference point. A GPS node is the target key for finding the exact latitude and longitude location and can be of an object (a person, vehicle, animal, or inanimate object) or specific geographical area. The network of GPS satellites 110 is an established system that was setup by the United States government that triangulates the target key's relative location. The RTK reference point is a private system that must be setup 24-hours prior to use and provides greater precision to find the target key's exact location.

The present invention's process has four broad functions: to locate specific geographical areas that will be used to define the race track 100, illustrated in FIG. 1 for clarity, and to continually locate, or track, objects 103 for the duration of a race, to specify the race objects including 3 dimensional data about each race object and to allow race data to be stored for future use including analysis of a race, rebroadcast and gaming.

The location of specific landmarks 102, 104, 106, 108, 120 and 122 over a specified geographical area will be used to define the race area, as illustrated in FIG. 1. The central collection unit 402 and specialized software helps in plotting out the landmarks to create the digital representation of the racecourse 302. The specialized software provides a list of suggested landmarks to survey or locate. The exact positions of specific landmarks are found by placing a GPS node at the physical location for 15 to 45 seconds. During that period the GPS satellite network and the RTK reference point collaborate on the exact position of the landmark. During the 15 to 45 second interval, specialized software takes 15 to 45 samples of the location of the landmark and averages the location coordinates with the time period, to rule out any error caused by movement of the GPS node during sampling. Upon locating the exact position of a landmark, it is labeled and the next landmark can be surveyed. Upon the completion of locating and labeling of all said landmarks the data is transferred by the central collection unit to adjacent servers to be saved. A similar process is used to store 3 dimensional data about each race object to establish size and shape of the object as well as orientation.

The centralized collection unit 402 can transmit the data packets directly to the Internet 405, by means of an Internet hub being physically connected to the central collection unit 402. If an Internet hub is not physically located in the vicinity of the central collection unit the specialized software is responsible for locating the best means to transmit the data packets to the Internet. Transmission can be through satellite communication, utilizing a satellite dish to transmit the data packets to specified satellites and on to specified adjacent servers. Transmission can also be through a series of radio networks that are meshed together to create an information pipeline to an established Internet hub. Radios are placed in range of each other, and continually transmit information to and from each other.

Specified landmarks that are to define the racing area, specifically the northwest and southeast corners. These specified landmarks have accurate longitude and latitude coordinates that are matched up with the corresponding coordinates on a satellite picture or map of the area. The map is then fixed upon the background with the landmarks set over the top. This is now the set area and display for a said race.

To find the location of an object 103 a GPS node 112 must be affixed to the object 103. The specialized software is used to label the specific GPS node 112 that is attached to a specific object 103 within a specific race. This enables the objects name, calling, or type to be displayed on the race view. For example object 103A is represented by object 303A on digital display 302 and data about object 103 A can be tracked on grid 310 and the object 103A can be represented by an identifier that identifies it to a user such as a number or name. The object 303A can be an animation of the actual car in the sense that it contains much more than just point data. The object 303A can contain information about the size and shape of the object and can contain 3Dimensional information that may not be fully displayed on a 2 dimensional screen such as display 302. The location of the object 103 is inherently found by the GPS node 112 locating its exact position from the collaboration between the network of GPS satellites 110 and the RTK reference 104 location. As the GPS node 112 locates its position it transmits the location coordinates and its heading, or direction of movement, to a central collection unit 402 periodically, or between 1/1000^{th} and once per second creating a pathway for the object over time. The GPS node 112 will continually receive and transmit its exact location. If the GPS node 112 is ever unable to receive or transmit its exact location the specialized software sends a notification to users of the error in transmission.

The central collection unit 402 is setup to receive at least one and possibly thousands of GPS node's location coordinates and headings every 1/1000^{th} per second to every once per second. The 3D data about each race object 103 can be stored in the central collection unit 402 and combined with speed and heading data to provide a complete digital transmission and record of the race. The flow chart 200 of collection unit 402 is illustrated in FIGS. 2,6,7,8 and 9 for clarity. Referring to FIG. 2, as the GPS node 112 transmits location 210 the central collection unit 402 immediately recognizes 212 the specified GPS nodes that correspond to specific objects 103 A, B, C. The information is bundled into data packets 404 by categorizing a specified race that each specified object 103 is entered in and then the specified location coordinates are tied to the corresponding specified object 103. The central collection unit 402 then transmits 240 the data packets through the Internet 405 to adjacently located servers 407.

The centralized collection unit 402 can transmit the data packets directly to the Internet 407, by means of an Internet hub being physically connected to the central collection unit 402. If an Internet hub is not physically located in the vicinity of the central collection unit the specialized software is responsible for locating the best means to transmit the data packets to the Internet. Transmission can be through satellite communication, utilizing a satellite dish to transmit the data packets to specified satellites and on to specified adjacent servers. Transmission can also be through a series of radio networks that are meshed together to create an information pipeline to an established Internet hub. Radios are placed in range of each other, and continually transmit information to and from each other.

Upon successful transmission and delivery of the data packets from the central collection 402 to the adjacently located servers 407, the data packets are saved and organized 224. The adjacently located servers 407, with the help of specialized software, then create a digital representation of the object and its course pathway. The digital representation can be an animation with size, shape color, 3 dimensional and indicia data for example. The adjacently located servers 407 and specialized software are responsible for calculating the speed, heading, course, and other relevant race information for each object instantaneously and coupling those calculated data with stored information about each car 103 and inputting that information into the digital representation.

The digital representation is transmitted 240 back to the central collection unit and is additionally transmitted to specific websites and cellular networks, by either direct a direct Internet hub connection, via a satellite link, through a mesh network of radios, or a combination of two. The central collection unit 402, Internet websites, and cellular networks receive the digital representation of at least one object moving within the specified area and the measurements of the speed and direction. The central collection unit, Internet websites, and cellular networks will receive the digital representation and speed measurements in real-time, or less than one to at most five seconds from when the object was physically in the location that digital representation depicts.

A specialized application enables the central collection unit 402 and Internet websites to view the digital representation and corresponding speed measurement from the movements of specified objects. An additional specialized application will enable cellular phone, PDA's, and handheld computer's to view the digital representations and corresponding speed measurements from the movements of specified objects, received from the Internet or a cellular network. The specialized applications may require downloading to a specified Internet or cellular enabled device or computer.

The node 112 acts as a hub for collecting its positioning data from the GPS. The node 112 will be equipped with a transmitter that will send the positioning data in a data packet to a remote collection unit 402. The remote collection unit 402 is capable of receiving and compiling hundreds data packets from different nodes simultaneously. The external collection unit then sends the compiled data packets to an adjacent server via the Internet 405. A specialized application is responsible for assigning nodes to the objects and for generating a digital representation from the data packets.

The methods for using GPS to track races fundamentally differ in the accuracy in the positioning of the nodes 112, the weight of the node hardware, and the type of transmitter that is used to transfer the data packets from a remote collection unit to the Internet. Accuracy can be enhanced through the use of an RTK, or real time kinematics. The weight of node hardware is limited by the rate of technological advancement in the industry. The different types of transmitters are cellular antennas, modems, radios, and satellite dish.

Accuracy can be enhanced to less than a centimeter by introducing another point of reference, RTK, within eyesight of the node 112. The RTK acts as a second reference point to further refine the accuracy of positioning from the GPS satellites. This device is typically referred to as a RTK, or real time kinematics.

The physical weight of the node 112, consisting of all the circuitry hardware to operate the node, is between two to ten pounds. This physical weight of the nodes 112 needs to light enough so as not to disrupt the race or placement of the objects 103.

The prior art four transmitters each have strengths and weaknesses. Cellular antennas are reliable so long as there is a cellular tower within range and there is sufficient bandwidth available for transmitting the information. Modems are a low-cost alternative when there is a lack of cellular coverage, however modems can fail to continually send information packets in certain geographical regions. Radios tend to be a more costly type of transmitter and have a low percentage of transmitting failure. Radios can also be linked together to form a communication chain that allows for information packets to be sent down a chain of radios that is out of a single radio's range. Satellite dish's are the most expensive transmitter and are the least susceptible to failure. However, satellites communication has been known to lag or take longer the normal to send an information packet.

FIG. 6 shows the process 600 of setting up a race track 100 to create a digital representation 302 for display. First points on the track are located 602 using GPS. 3 Dimensional data can be stored about each point on the track. A reference point can be located 604 for placement of an RTK and other points on a map 606 can be located. Then a graphical representation of the map is created. The map 500 can be displayed in 2 dimensions but can contain 3 dimensional information. The graphical map can then be transmitted for display.

FIG. 7 shows a process 700 that can be used to add an animated car to the display 310. Number 710 and the dashed line indicate a sub-process by which an animated racecar that matches an actual racecar is created. The exact location of the GPS node placed on the car is recorded. Then the GPS is oriented to point towards the front of the car. The car node is thereby specified from the actual car 712 by taking multiple points on the car with a GPS node 112. Then a 3D representation of an actual race car is created 714 and stored in the central data collection 402. The animated car created will match the actual car in scaled dimensions, color and insignia. This will allow race fans to recognize their favorite racer. The animated car matches 718 the actual dimensions of the actual car at a scale that matches a digital recreation of the racetrack such that the physical relationship of all the cars and track points of reference can be tracked.

FIG. 7 also includes a speedway animation process 730 shown by a second dashed line. The first step in developing a digital representation of the racetrack 100 is to specify the racetrack similar to the process shown in FIG. 6 where points are located using GPS 602, a reference point is located 614, locate points on a map and create a graphical representation of the map 608. The graphical map can then be displayed 610. The graphical map can then be used to create a 3D animation of the racetrack 734 and the animated track can be uploaded to a server 736. The process 740 can be used to track the actual cars 103 on the actual track 100 taking GPS packets for each car 103 in a race. Packets show position of cars 103 over time. The pathway represented in the packets is overlaid onto the 3D animated speedway 738 and the animated car follows 720 the digital pathway on the animated racetrack. All the animated cars follow specific pathways replicating the actual race.

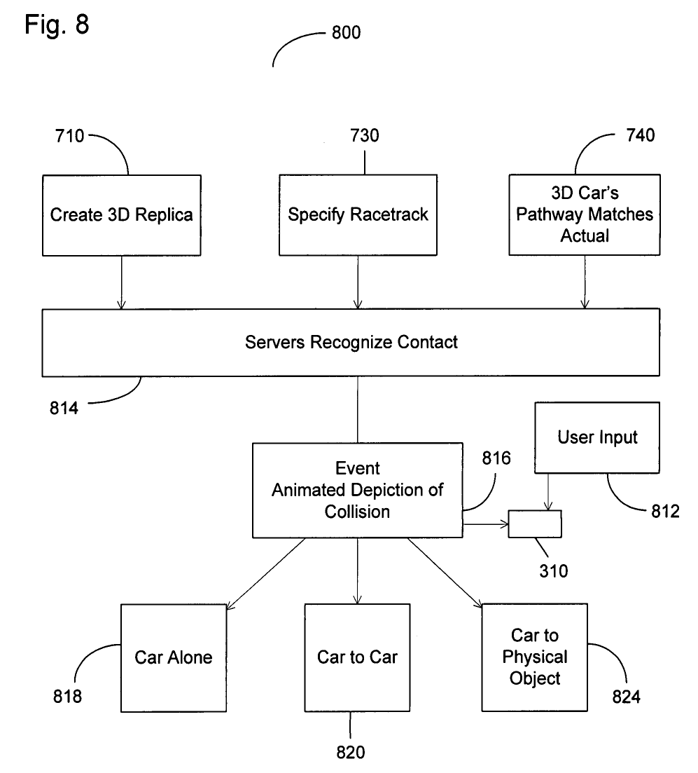

FIG. 8 shows the event process 800 of displaying specific evens that occur on the actual race track 100 on the display 302. The processes of creating the 3D animated replica car 710, specifying the race track 730, and matching the animated car's path to the actual racecar 740 are shown as the starting steps to the event process 800. As the a race proceeds the server processing the information including pathway packets may recognize and event or near event such as cars colliding or a car colliding with a track object, a car leaving the race field either for a pit stop or by accident or a car passing the finish line for example. The server upon recognizing an even can send an event signal to the display device 310. The event signal might include an animated depiction of a collision 816. A collision would be detected when the 3D replica between two object come close together, the server might also recognize the rebound that occurs when a car strikes another object. The depiction 816 might include a vibration or audio signal to alert a user to the event and the depiction would include a visual display such as sparks between the animated cars. FIG. 8 shows that events can occur with a car alone 818 for example a car might lose an engine and suddenly slow down, this might be accompanied by animated smoke rising from the car. Another car alone event 818 might be crossing the finish-line; this can be accompanied by checkered flags, or animated ticker tape with the winning car 103. An event can be a car to car event 820 such as a collision, near miss, one car passing another or one car passing the leader and taking the lead for example. An event might be a car to a physical object such as a car sliding sideways relative to the track, leaving the track or hitting an object. FIG. 8 shows that data about an event 816 flows to a user device and that the user can influence what they see from their device 310. So a user may want to primarily watch an animation of their favorite race car 103a but the process 800 may alert them to an event on the track 100 outside their view for example (Referring to FIG. 1) a user may be watching an animation of car 103B and may be able to see cars 103a and 103C in the same view but an event may occur where car 103 D suddenly slides sideways as detected by the car moving in a direction perpendicular or at an angle to the heading of the GPS device. When this event occurs the user might see a text notice, “Car 103D goes into a slide!” the user might feel a vibration or the view might change automatically when the system 800 detects an event. The control over what is defined as an event can be within the control of the user who might enter an instruction into the user device such as “Show me all events”. All data from a race can be saved on the server 407 (FIG. 4) and race events can be broadcast live as the race occurs to fans at the race and to fans not at the race. Saved races can also be accessed through the Internet 405 or other networks such that a fan, a race official or race driver for example can review a race and use old race data.

FIG. 9 shows a process 900 that allows an online gamer or multiple gamers to play a 3D race after an actual race occurs from a digital record of the race. In step 902 the gamer picks a car. The car might be a car that did not participate in the actual race or the gamer might chose to take control of one of the cars that actually raced. The gamer then picks a speedway and race event from an on line catalog of digital records of historical races. Gamers can then run time trials on an animated track that matches an actual track 100 stored in the server. The gamer can then receive a pole 910 position based on his time trial data compared to actual race drivers at the same historical event. All 3D racecars (including those based on cars that participated in the historical race) are lined up 912 and the gamer assumes his position among them. The historical pathways of all cars are entered 920, data can be slightly altered if need be to compensate for the new car or alternatively the gamer can take control of one of the historical cars that scored a time trial closest to his result. The race then starts 930 with the animated cars following their historical pathways except for the gamers car that can move independently. The gamer will race and try to win against the historical racers. If one gamer is playing a game event 950 such as a wreck will end the game. If multiple gamers are playing an event 950 may take a gamer and a historical car out of the race. Historical events will also be depicted during the gamer race. If one gamer is eliminated others may continue the race. An event may cause a yellow flag or red flag pause in the game while the remaining cars are reset so the race can continue. If the historical race is based of a number of laps then completion of the laps by a historical car or the gamer controlled car will result in a checkered flag win 960. Placement of the racers at the finish will be determined by the order in which they cross the animated finish line 102. The gamer race can be a portion of the original race, for example a gamer might only want to run 5 laps out of an original 100 lap race.

What is claimed is:

1. A method for tracking objects motion in real-time, comprising the steps of:
specifying coordinates to generate a map in which to track a plurality of objects;
coupling at least one GPS node to at least one object to be tracked in the specified area;
periodically transmitting, between the at least one GPS node and a plurality of GPS satellites; receiving a location of the GPS node coupled with the object;
calculating a heading of the object;
transmitting the location and heading of the object from the GPS node to a central collection point;
receiving location and heading of each object in real-time, periodically transmitting location and heading to an adjacent server; receiving the location and heading of each object by the adjacent server;
generating a digital representation of the location and heading of each object by specialized software within the adjacent server;
combining said digital representation of the location and heading with stored 3 dimensional information about the object;
adding data to a live digital representation of the object and
periodically transmitting, said live digital representation of the object from the central collection point, to the Internet and cellular devices.

2. The method of claim 1, wherein the processing step includes the step of creating a playback of past objects racing in real-time at a future time and date.

3. The method of claim 1, wherein the processing step further includes the step of establishing a specified application enabling the digital representation of the objects racing to be viewed through the Internet and cellular-enabled devices and wherein the digital representation contains 3 dimensional information.

4. The method of claim 1, wherein the object includes three dimensional data including size and shape and wherein the step of transmitting to said server includes the step of storing race data for future retrieval.

5. The method of claim 2, wherein said step of creating a playback includes a step of conducting a live time trial on a digital representation of a historical race track.

6. The method of claim 2, wherein said step of creating a playback includes a step of loading pathways followed by actual vehicles in a race and allowing a user to race an animated vehicle against animated cars from said playback.

7. The method of claim 1 wherein the step of adding data to said live digital representation includes generating a signal in response to an event that occurs in a live race and wherein said signal causes a response in a digital viewing device.

8. The method of claim 7 wherein the step of adding data includes creating a signal to cause a vibration in said digital viewing device.

9. The method of claim 7 wherein the step of adding data includes creating a signal to cause an animated flame to appear on said object.

10. The method of claim 7 wherein said step of adding data includes displaying information depicting a collision between said object and a second object.

11. A method for displaying and tracking race objects comprising the steps of: specifying coordinates to generate a map in which to track a plurality of objects in an area;
storing 3 dimensional data about said objects,
coupling at least one GPS node to at least one object to be tracked in the area;
periodically transmitting, between the GPS node and a plurality of GPS satellites;
receiving a location of the GPS node coupled with the at least one object;
calculating a heading of the at least one object;
transmitting the location and heading of the at least one object from the GPS node to a central data collection point;
transmitting said location and heading to an adjacent server; receiving the location and heading of each object by the adjacent server;
generating a live digital representation of the location and heading of each object at the adjacent server;
combining the digital representation with the 3 dimensional periodically transmitting said live digital representation of the object to the central collection point and to a network.

12. The method of claim 11 wherein said objects are racecars and the step of storing 3 dimensional data includes storing information about the race cars size, shape, orientation and color.

13. The method of claim 11 wherein the step of storing 3 dimensional data includes the step of placing a GPS mode on multiple points on said object and recording GPS data about the object.

14. The method of claim 11 wherein said object is a race car and wherein the step of storing three dimensional data about the object includes placing a GPS node at a plurality of points on said racecar and recording GPS data about the size and shape of the car and storing said 3 dimensional data in said central data collection point.

15. A method for displaying and tracking race objects comprising the steps of:
specifying coordinates to generate a map in which to track a plurality of objects;
storing 3 dimensional data about said objects to create stored 3 dimensional information, coupling at least one GPS node to at least one object to be tracked in the area;
periodically transmitting, between the GPS node and a plurality of GPS satellites;
receiving a location of the GPS node coupled with the at least one object;
calculating a heading of the at least one object;
transmitting the location and heading of the at least one object from the GPS node to a central data collection point;
receiving location and heading of each object in real-time, transmitting location and heading to an adjacent server; receiving the location and heading of each object by the adjacent server;
generating a live digital representation of the location and heading of each object at the adjacent server;
adding data to a live digital representation and
combining said stored 3 dimensional information with said digital representation of each object and to create a digital race record and
periodically transmitting said digital race record to a network.
